(19) United States
(12) Patent Application Publication
(10) Pub. No.: US 2009/0023851 A1
(43) Pub. Date: Jan. 22, 2009

(54) PROCESS FOR THE PRODUCTION OF AN ELECTRICALLY CONDUCTING POLYMER COMPOSITE MATERIAL

(75) Inventors: Michael BIERDEL, Leverkusen (DE); Sigurd BUCHHOLZ, Koln (DE); Volker MICHELE, Koln (DE); Leslaw MLECZKO, Dormagen (DE); Reiner RUDOLF, Leverkusen (DE); Aurel WOLF, Wulfrath (DE)

Correspondence Address: NORRIS, MCLAUGHLIN & MARCUS, P.A., 875 THIRD AVE, 18TH FLOOR, NEW YORK, NY, 10022, US

(73) Assignee: BAYER MATERIALSCIENCE AG, Leverkusen (DE)

(21) Appl. No.: 12/143,983

(22) Filed: Jun. 23, 2008

(30) Foreign Application Priority Data
Jun. 23, 2007 (DE) 10 2007 029 008.1

(51) Int. Cl. C08K 3/04; D01D 5/24

(52) U.S. Cl. 524/495; 264/209.1; 977/742

(57) ABSTRACT

Process for the production of an electrically conducting carbon nanotube polymer composite material with reduced surface resistance, in which carbon nanotubes are dispersed in a polymer melt in a twin-shaft screw extruder to form a mixture, and the mixture is then extruded.

The present invention relates to a process for the production of an electrically conducting polymer composite material with reduced surface resistance, based on thermoplastic polymers and carbon nanotubes, in which a carbon nanotube polymer melt mixture is dispersed in a twin-shaft screw extruder and then extruded. The carbon nanotubes are hereinafter referred to, in short, as “CNT”.

### BACKGROUND OF THE INVENTION

A process of this type is known in principle from WO 2005/014259 A1. According to this a CNT polymer mixture is mixed in a batch operation in a mini twin-screw extruder with co-rotating, conical screws and a reflux channel, and is extruded after multiple passages through the extruder. The process is suitable only for laboratory scale operations, the processed amounts being 4-15 grams. A scaling-up to an industrial scale (i.e. a throughput in the region of tons per hour) is not possible or is at least extremely difficult, since the basic apparatus is not suitable for a continuous large-scale operation. The dispersion of the CNT takes place in this case basically through hydrodynamic forces.

In WO 2001/092381 A1 a process is described in which a CNT polymer mixture is produced, the dispersion of the CNT in the polymer melt being effected by hydrodynamic forces. The process can be implemented in an extruder, a rheometer or a fibre spinning machine.

The object of the invention is to disperse highly convoluted CNT agglomerates with a mean diameter of 0.5-2 mm, such as are obtained for example according to WO 2006/050903 A2 by catalytic gaseous phase deposition, in a polymer melt and to separate out the CNT and distribute them homogeneously in a polymer in such a way that the CNT form a three-dimensional, electrically conducting network in the polymer. In particular the process should be suitable for the dispersion of multi-walled carbon nanotubes, referred to, in short, as MWNT. Moreover the process should be able to be modified (be applied) without any problem for throughputs on an industrial scale, i.e. should be able to be scaled up to large throughputs of the order of tons/hour.

### SUMMARY OF THE INVENTION

According to the invention this object is achieved on the basis of the process described in the introduction if thermoplastic polymer in the solid phase is fed together with the carbon nanotubes (CNT) to the main feed opening of a twin-shaft co-rotating twin screw extruder or a ring extruder or a planetary roller extruder or a co-kneader with non-conical shafts, and the CNT are pre-dispersed in the solids conveying zone by the action of friction between the solids with the formation of a solids mixture, and if the polymer or the polymers is/are melted in a downstream melting zone and also the CNT are further dispersed in this melting zone predominantly under the action of hydrodynamic forces and are homogeneously distributed in further zones in the polymer melt.

The dispersion of the MWNT by the application of hydrodynamic forces alone, as described in WO 2001/092381 A1, was not successful for the MWNT obtained from the catalytic gaseous phase process.

### DETAILED DESCRIPTION

In a preferred process the specific mechanical energy input in the screw extruder is adjusted to a value in the range from 0.1 kWh/kg to 1 kWh/kg, preferably from 0.2 kWh/kg to 0.6 kWh/kg, and the minimum residence time is adjusted to a value in the range from 6 sec to 90 sec., preferably 8 sec to 30 sec.

It was expected that, with increasing energy input, the CNT would be separated out more efficiently, but the length of the CNT would also constantly decrease. Since according to general theoretical considerations the electrical conductivity decreases with a decreasing length/diameter ratio (L/D ratio)—for a constant CNT content and degree of dispersion—it was expected that, with increasing energy input the electrical conductivity would first of all rise on account of the better separating out of the CNT, but would then fall again on account of the decreasing L/D ratio of the CNT. It was surprisingly found however that even with high energy input the electrical conductivity does not fall again.

The process according to the invention has the advantage that CNT polymer composite materials with CNT homogenously distributed in the polymer matrix and with a high electrical conductivity, high thermal conductivity and very good mechanical properties can be produced in an economically efficient manner on an industrial scale.

Preferably multi-walled carbon nanotubes are used in the new process.

Particularly preferably carbon nanotubes with a ratio of length to external diameter of greater than 5, preferably greater than 100, are employed.

The carbon nanotubes are particularly preferably used in the form of agglomerates, the agglomerates in particular having a mean diameter in the range from 0.5 to 2 mm. A further preferred process is characterised in that the carbon nanotubes have a mean diameter from 3 to 100 nm, preferably 3 to 80 nm.

The CNT that have become known from WO 2006/050903 A2 are particularly preferably used in the new process.

As thermoplastic polymer there is preferably used at least one polymer selected from the group consisting of polycarbonate, polyamide, polyester, in particular polybutylene terephthalate and polyethylene terephthalate, polyether, thermoplastic polyurethane, polyacetal, fluorinated polymers, in particular polyvinylidene fluoride, polyether sulfones, polyolefin, in particular polyethylene and polypropylene, polyimide, polyacrylate, in particular polymethylmethacrylate, polyphenylene oxide, polyphenylene sulfide, polyether ketone, polyarylether ketone, styrene polymers, in particular polystyrene, styrene copolymers, in particular styrene acrylonitrile copolymer, acrylate rubber (ASA), acrylonitrile-butadiene-styrene block copolymers and polyvinyl chloride.

The invention furthermore provides a carbon nanotube polymer composite material obtained by the process according to the invention.

The invention moreover also provides for the use of the carbon nanotube polymer composite material obtained by the process according to the invention, for the production of moulded articles.

The invention is described in more detail hereinafter with the aid of examples of implementation and the drawings, in which:

### BRIEF DESCRIPTION OF THE DRAWINGS

FIG. 1 shows diagrammatically an arrangement for carrying out the process

FIG. 2 is a diagrammatic longitudinal representation of the twin-shaft extruder employed in the arrangement according to FIG. 1

FIG. 3 shows a measurement arrangement for determining the electrical surface resistance of the CNT polymer composite materials.

### EXAMPLES

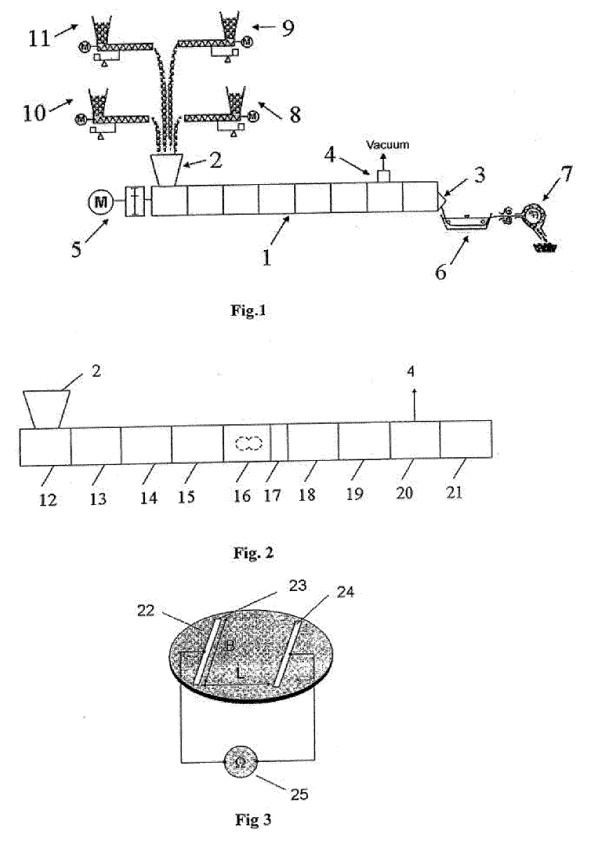

The arrangement according to FIG. 1 consists essentially of a twin-shaft screw extruder 1 with a hopper 2, a product outlet 3 and a vent 4. The two screw shafts (not shown) of the extruder 1 rotating in the same direction are driven by the motor 5. The constituents of the carbon nanotube polymer composite material (polymer P₁, additives (for example antioxidants, UV stabilisers, mould release agents), CNT, optionally polymer P₂) are conveyed via metering screws 8-11 to the feed funnel 2 of the extruder 1. The melt strands leaving the nozzle plate 3 are cooled and solidified in a water bath 6 and men comminuted with a granulator 7.

The twin-screw extruder 1 (see FIG. 2) comprises inter alia a housing consisting of ten parts, in which are arranged two screw shafts (not shown) intermeshing with one another and rotating in the same direction. The components, including the CNT agglomerates, to be compounded are fed to the extruder 1 via the feed funnel 2 arranged on the housing part 12.

A solids conveying zone, which preferably consists of thread elements with a pitch equal to twice the screw shaft diameter (abbreviated to: 2 D) to 0.9 D, is located in the region of the housing parts 12 to 13. By means of the thread elements the CNT agglomerates together with the other constituents of the carbon nanotube polymer composite material are conveyed to the melting zone 14, 15, and the CNT agglomerates are at the same time intensively mixed and pre-dispersed due to frictional forces between the polymer granules in the solid phase and the CNT powder which is likewise in the solid phase.

The melting zone, which preferably consists of kneading blocks, is located in the region of the housing parts 14 to 15; however, depending on the polymer, a combination of kneading blocks and toothed mixing elements may alternatively also be used. The polymeric constituents are melted in the melting zone 14, 15 and the pre-dispersed CNT and additives are further dispersed and intensively mixed with die remaining composite material components. The heating temperature of the extruder housing in the region of the melting zone 14, 15 is adjusted to a value that is greater than the melting point of the polymer (in the case of partially crystalline thermoplastics) or of the glass transition temperature (in the case of amorphous thermoplastics).

Downstream of the melting zone 14,15 in the region of the housing parts 16 to 19 a post-dispersion zone is provided between the conveying elements of the screw shafts. This post-dispersion zone comprises kneading and mixing elements which produce a frequent re-arrangement of the melt flows and a broad residence time distribution. In this way a particularly homogeneous distribution of the CNT in the polymer melt is achieved. Very good results have been obtained with toothed mixing elements. In addition screw mixing elements, eccentric discs, back-conveying elements, etc., can also be used for mixing the CNT. Alternatively several post-dispersion zones can also be arranged behind one another in order to intensify the fine dispersion. The important factor in achieving as uniform a CNT distribution as possible in the polymer is to ensure in each case the combination of the pre-dispersion in the solid phase, the main dispersion in the melting of the polymer or polymers, and the downstream fine dispersion, which takes place in the liquid phase.

The removal of volatile substances occurs in a degassing zone in the housing part 20 via a degassing opening 4, which is connected to a suction device (not shown). The degassing zone consists of thread elements with a pitch of at least 1 D.

The last housing part 21 contains a pressure build-up zone, at the end of which the compounded and degassed product leaves the extruder. The pressure build-up zone 21 comprises thread elements with a pitch between 0.5 D and 1.5 D.

The obtained CNT polymer composite material granules can then be processed further by all known thermoplastics processing methods. In particular moulded articles can be produced by injection moulding.

The measurement of the electrical surface resistance was carried out as illustrated in FIG. 3. Two electrically conducting silver stops 23, 24, the length B of which coincides with their interspacing L so as to define a square area (square), are mounted on the circular test body 22 of diameter 80 mm and thickness 2 mm, produced by means of an injection moulding technique. The electrodes of a resistance measuring device 25 are then pressed onto the conducting silver strips 23, 24 and the resistance value is read on the measuring instrument 25. 9 volts was used as measurement voltage for resistances of up to 3×10⁷ ohm/square, and 100 volts for resistances above 3×10⁷ ohm/square.

### Example 1

The incorporation of multi-walled carbon nanotubes (commercial product: Baytubes® C 150P (CNT produced by catalytic gaseous phase deposition according to WO 2006/050903 A2), manufacturer: Bayer MaterialScience AG) in polycarbonate (PC) (commercial product: Makrolon® 2800, manufacturer Bayer MaterialScience AG) is carried out in a ZSK 26Mc type twin-shaft screw extruder (Copenon Werner & Pfleiderer). In tests 1 and 2 the polymer granules as well as the CNT are metered through the main feed point and filling funnel 2 into the extruder. In tests 3 and 4 (comparison tests) the polymer is metered into the main feed 2 and the CNT is fed through a side feeder point 26 (shown in FIG. 2 by dotted lines in the housing part 16) into the polymer melt.

The process parameters are given in the following Table 1.

The melt temperature is measured with a commercially available temperature sensor directly in the melt strand leaving the nozzle plate 3.

The specific mechanical energy input is calculated according to the following equation:

Specific mechanical energy input=2×Pi×rotational speed×torque of the shafts/throughput.

The numbers and diameters of the non-completely dispersed CNT agglomerates contained in the carbon nanotube polymer composite material are measured by means of a light microscope on a 5 cm long strand from the CNT polymer composite material.

TABLE 1

| | | | Test No. | Test No. | Test No. | Test No. |
|---|---|---|---|---|---|---|
| | | | 1: PC127 | 2: PC128 | 3: PC130 | 4: PC131 |
| CNT amount | wt. % | | 0.2 | 0.2 | 0.2 | 0.2 |
| Throughput | kg/hour | | 18 | 25 | 18 | 25 |
| Rotational speed | l/min | | 400 | 600 | 400 | 600 |
| Specific mechanical | kWh/kg | | 0.2977 | 0.3133 | 0.2901 | 0.3133 |
| energy input | | | | | | |
| Housing temperature | ° C. | | 240 | 240 | 240 | 240 |
| in the melting zone | | | | | | |
| Melt temperature | ° C. | | 328 | 346 | 330 | 348 |
| Particle nos. in the | μm | 0.5-10 | 30 | 20 | 80 | 60 |
| diameter range | | 10-20 | 6 | 3 | 20 | 30 |
| | | 20-40 | 2 | 1 | 20 | 30 |
| | | 40-60 | 0 | 0 | 0 | 0 |

It can clearly be seen that when the CNT is metered into the main feed point (tests 1 and 2) a significantly better dispersion (—significantly fewer CNT residual agglomerates in all class sizes) is achieved than when the CNT is fed into the polymer melt (tests 3 and 4). From this it follows that a dispersion of the CNT agglomerates by purely hydrodynamic forces (in the case of comparison tests 3 and 4) is insufficient.

### Example 2

### Varying the CNT Amount

The incorporation of multi-walled carbon nanotubes (commercial product; Baytubes® C 150 P (CNT produced by catalytic gaseous phase deposition according to WO 2006/050903 A2), manufacturer Bayer MaterialScience AG) in polycarbonate (PC) (commercial product: Makrolon® 2800, manufacturer Bayer MaterialScience AG) is carried out by the method according to the invention in a ZSK 26Mc type twin-shaft screw extruder (Copenon Werner & Pfleiderer).

The polymer granules and the CNT are metered in through the main feed point 2 of the extruder. The granules obtained are then injection moulded into test bodies and their electrical surface resistance is measured as illustrated in FIG. 3. Two electrically conducting silver strips whose length B is the same as their interspacing L are pressed onto circular plates (test bodies) produced by means of an injection moulding technique. The electrodes of a resistance measuring instrument were then pressed onto the conducting silver strips and the resistance value was read on the measuring instrument. 9 volts was used as measurement voltage for resistances up to 3×10⁷ ohm/square, and 100 volts for resistances above 3×10⁷ ohm/square.

The surface resistance of pure Makrolon® 2800 is 10¹⁶ ohm/square according to the manufacturer's data sheet.

The process parameters and measured surface resistances are given in the following Table 2.

The minimum residence time was determined as follows;

First of all pure PC was extruded until a transparent strand left the nozzle plate 3. Then ca. 0.5 g CNT was metered in addition to the PC granules into tire main feed point 2 of the extruder, and the time until the melt strand leaving the nozzle plate 3 became discoloured was measured with a stopwatch. This time is the minimum residence time.

TABLE 2

| | | Test No. | Test No. | Test No. | Test No. |
|---|---|---|---|---|---|
| | | 5: PC433 | 6: PC434 | 7: PC435 | 8: PC436 |
| CNT amount | wt. % | 2 | 3 | 5 | 7.5 |
| Throughput | kg/h | 26 | 26 | 24 | 22 |
| Rotational | l/min | 400 | 400 | 400 | 400 |
| speed | | | | | |
| Specific | kWh/kg | 0.263 | 0.2562 | 0.2849 | 0.3148 |
| mechanical | | | | | |
| energy input | | | | | |
| Housing | ° C. | 205 | 205 | 205 | 205 |
| temperature | | | | | |
| in the | | | | | |
| melting zone | | | | | |
| Minimum | s | 10.2 | 10.2 | 10.7 | 11.4 |
| residence time | | | | | |
| Surface | Ohm/sq | 1.58 × 10⁵ | 7.74 × 10³ | 2.48 × 10³ | 4.98 × 10² |
| resistance | | | | | |

### Example 3

### Variation in the Energy Input

The incorporation of multi-walled carbon nanotubes (commercial product: Baytubes® C 150 P (CNT produced by catalytic gaseous phase deposition according to WO 2006/050903 A2), manufacturer Bayer Technology Services) in polycarbonate (PC) (commercial product: Makrolon® 2800, manufacturer Bayer Material Science AG) is carried out by the method according to the invention in a ZSK 26Mc type twin-shaft screw extruder (Coperion Werner & Pfleiderer).

The polymer granules and the CNT are metered in via the main feed 2 of the extruder. The granules obtained are then injection moulded into test bodies and their electrical surface resistance is measured as illustrated in FIG. 3.

Tire process parameters and measured surface resistances are given in the following Table 3.

TABLE 3

| | | Test No. | Test No. | Test No. | Test No. | Test No. |
|---|---|---|---|---|---|---|
| | | 9: PC415 | 10: PC408 | 11: PC409 | 12: PC410 | 13: PC396 |
| CNT amount | wt. % | 5 | 5 | 5 | 5 | 5 |
| Throughput | kg/h | 24 | 27 | 18 | 9 | 3 |
| Rotational speed | l/min | 400 | 600 | 600 | 600 | 200 |
| Specific mechanical | kWh/kg | 0.2849 | 0.296 | 0.3848 | 0.592 | 0.7252 |
| energy input | | | | | | |
| Housing temperature | ° C. | 205 | 2.05 | 205 | 205 | 205 |
| in the melting zone | | | | | | |
| Minimum residence | s | 10.7 | 8.9 | 12.1 | 23 | 73 |
| time | | | | | | |
| Surface resistance | Ohm/sq | 6.45 × 10³ | 3.65 × 10³ | 2 × 10³ | 1.83 × 10³ | 5.13 × 10³ |

It can be seen that the resistance first of all decreases with increasing energy input, but then with high energy input does not significantly rise as expected due to CNT comminution, but still remains below the level for a low energy input (test 9).

### Example 4

### Variation of the CNT Amount

The incorporation of multi-walled carbon nanotubes (commercial product: Baytubes® C 150 P (CNT produced by catalytic gaseous phase deposition according to WO 2006/050903 A2), manufacturer Bayer Material Science AG) in polybutylene terephthalate (PBT) (commercial product: Pocan® B 1600, manufacturer Lanxess Deutschland GmbH) is carried out by the method according to the invention in a ZSK 26Mc type twin-shaft screw extruder (Coperion Werner & Pfleiderer).

The polymer granules and the CNT are metered in via the main feed point 2 of the extruder. The granules obtained are then injection moulded into test bodies and their electrical surface resistance is measured as illustrated in FIG. 3.

The surface resistance of pure Pocan® B 1600 is according to Campus Datenbank >10¹⁵ ohm/square.

The process parameters and measured surface resistances are shown in the following Table 4.

TABLE 4

| | | Test No. | Test No. | Test No. | Test No. |
|---|---|---|---|---|---|
| | | 14: PBT2 | 15: PBT3 | 16: PBT4 | 17: PBT5 |
| CNT amount | wt. % | 2 | 3 | 5 | 7.5 |
| Throughput | kg/h | 15 | 17 | 19 | 19 |
| Rotational | l/min | 400 | 400 | 400 | 400 |
| speed | | | | | |
| Specific | kWh/kg | 0.4440 | 0.3917 | 0.3692 | 0.3692 |
| mechanical | | | | | |
| energy input | | | | | |
| Housing | ° C. | 205 | 205 | 205 | 205 |
| temperature | | | | | |
| in the | | | | | |
| melting zone | | | | | |
| Minimum | s | 16.1 | 15.7 | 14.2 | 14.2 |
| residence time | | | | | |
| Surface | Ohm/sq | 1.46 × 10⁸ | 2.24 × 10⁵ | 7.61 × 10² | 9.33 × 10¹ |
| resistance | | | | | |

### Example 5

### Variation of the CNT Amount

The incorporation of multi-walled carbon nanotubes (commercial product: Baytubes® C 150 P (CNT produced by catalytic gaseous phase deposition according to WO 2006/050903 A2), manufacturer Bayer MaterialScience AG) in polyamide 6 (PA 6) (commercial product: Durethan® B 29, manufacturer Lanxess Deutschland GmbH) is carried out by the method according to the invention in a ZSK 26Mc type twin-shaft screw extruder (Coperion Werner & Pfleiderer).

The polymer granules and the CNT are metered in via the main feed point 2 of the extruder. The granules obtained are then injection moulded into test bodies and their electrical surface resistance is measured as illustrated in FIG. 3.

The surface resistance of pure Durethan® B 30, which is comparable to that of the used Durethan® B 29, is according to Campus Datenbank 10¹³ ohm/square.

The process parameters and measured surface resistances are shown in the following Table 5.

TABLE 5

| | | Test No. | Test No. | Test No. |
|---|---|---|---|---|
| | | 18: PA58 | 19: PA59 | 20: PA60 |
| CNT amount | wt. % | 3 | 5 | 7.5 |
| Throughput | kg/h | 24 | 22 | 21 |
| Rotational speed | l/min | 400 | 400 | 400 |
| Specific mechanical | kWh/kg | 0.2812 | 0.3027 | 0.3213 |
| energy input | | | | |
| Housing temperature | ° C. | 190 | 190 | 190 |
| in the melting zone | | | | |
| Minimum residence | s | 10.7 | 11.4 | 11.7 |
| time | | | | |
| Surface resistance | Ohm/sq | >1.00 × 10¹¹ | 1.53 × 10⁶ | 6.16 × 10⁵ |

1. Process for the production of an electrically conducting carbon nanotube polymer composite material, in which carbon nanotubes and thermoplastic polymer are mixed in a twin-shaft screw extruder or a ring extruder or a planetary roller extruder or a co-kneader with non-conical shafts rotating in the same direction and having a main feed (2), a solids conveying zone (12, 13), and a heated melting zone (14, 15), and are then extruded, wherein
a) the carbon nanotubes together with the polymer or polymers and optionally additives, in the solid phase, are fed to the main feed (2) of the screw extruder (1), the carbon nanotubes are pre-dispersed in the solids conveying zone (12,13) of the extruder by frictional forces between the solids, with the formation of a solids mixture, the solids mixture is then conveyed to the melting zone where the polymer is heated to a temperature above its melting point or glass transition temperature, to form a melt, and the solids are further dispersed in the polymer melt in the melting zone (14, 15), predominantly due to hydrodynamic forces, and
b) the resulting mixture is further post-dispersed in at least one further zone (16, 17, 18, 19) of the screw extruder (1) the carbon nanotubes thereby being homogeneously distributed in the polymer melt.

2. Process according to claim 1, wherein the specific mechanical energy input in the screw extruder (1) is adjusted to a value in the range of from 0.1 kWh/kg to 1 kWh/kg and the minimum residence time in the extruder is adjusted to a value in the range from 6 sec to 90 sec.

3. Process according to claim 2, wherein the specific mechanical energy input in the screw extruder (1) is adjusted to a value in the range from 0.2 kWh/kg to 0.6 kWh/kg and the minimum residence time is adjusted to a value in the range from 8 sec to 30 sec.

4. Process according to claim 1, wherein said carbon nanotubes are multi-walled carbon nanotubes.

5. Process according to claim 1, wherein said carbon nanotubes have a ratio of length to external diameter of greater than 5.

6. Process according to claim 5, wherein said ratio is greater than 100.

7. Process according to claim 1, wherein said carbon nanotubes are in the form of agglomerates.

8. Process according to claim 1, wherein said carbon nanotubes have a mean diameter of from 3 to 100 nm.

9. Process according to claim 8, wherein said mean diameter is from 3 to 80 nm.

10. Process according to claim 1, wherein the thermoplastic polymer is at least one polymer selected from the group consisting of polycarbonate, polyamide, polyester, polyether, thermoplastic polyurethane, polyacetal, fluorinated polymers, polyether sulfones, polyolefin, polyimide, polyacrylate, polyphenylene oxide, polyphenylene sulfide, polyether ketone, polyarylether ketone, stymie polymers, styrene copolymers, acrylate rubber (ASA), acrylonitrile-butadiene-styrene block copolymers and polyvinyl chloride.

11. Process according to claim 10, wherein said thermoplastic polymer is at least one polymer selected from the group consisting of polybutylene terephthalate, polyethylene terephthalate, polyvinylidene fluoride, polyethylene, polypropylene, polymethylmethacrylate, polystyrene and styrene acrylonitrile copolymer.

12. Carbon nanotube polymer composite material obtained by the process of claim 1.

13. Moulded articles comprising the carbon nanotube polymer composite of claim 12.
